(19) United States
(12) Patent Application Publication
(10) Pub. No.: US 2022/0248107 A1
(43) Pub. Date: Aug. 4, 2022

(54) METHOD, APPARATUS, ELECTRONIC DEVICE, AND STORAGE MEDIUM FOR SOUND EFFECT PROCESSING DURING LIVE STREAMING

(71) Applicant: ALIBABA GROUP HOLDING LIMITED, Grand Cayman (KY)

(72) Inventors: Xu Jin, Hangzhou (CN); Ding Jiandong, Hangzhou (CN)

(21) Appl. No.: 17/541,731

(22) Filed: Dec. 3, 2021

(30) Foreign Application Priority Data
Dec. 29, 2020 (CN) 202011608750.9

(51) Int. Cl. H04N 21/81; H04N 21/2187; H04N 21/439; H04N 21/44; H04N 21/442

(52) U.S. Cl. CPC H04N 21/8106; H04N 21/2187; H04N 21/44218; H04N 21/44008; H04N 21/4394

(57) ABSTRACT

Provided in example embodiments are a method, apparatus, electronic device, and storage medium for data processing. The method can include obtaining live broadcast streaming data for live broadcast streaming media and determining status information of the live broadcast streaming media based on the live broadcast streaming data; determining sound effect data based on the status information of the live broadcast streaming media; and incorporating the sound effect data in the live broadcast streaming data to obtain target live broadcast streaming data, the target live broadcast streaming data for transmitting to a target user. The invention facilitates an operation of a presenter.

### CROSS-REFERENCE TO RELATED APPLICATIONS

This application claims the benefit of priority of Chinese Application No. 202011608750.9 filed Dec. 29, 2020, which is hereby incorporated by reference in its entirety.

### BACKGROUND

### Technical Field

The present application relates to the technical field of computer technologies, and in particular, to the processing of live streaming data.

### Description of the Related Art

With the rise of various live streaming platforms, more and more people have participated in providing streaming media. To make streaming media content more appealing, some presenters usually include a sound effect in the streaming media content. For example, after the presenter tells a joke, the presenter may manually select an “applause” sound effect from a large number of sound effects. The selection results in including the sound effect in the streaming data transmitted to the audience. However, in this manner, the presenter needs to manually select a sound effect from a large number of sound effects and include the sound effect in the streaming media content. Therefore, it is inconvenient for the presenter to operate.

### BRIEF SUMMARY

Provided in the example embodiments are methods for data processing to facilitate the operations of a presenter during live streaming. Correspondingly, further provided in the example embodiments are apparatuses for data processing, electronic devices, and storage media to ensure the implementation and application of the above-mentioned system.

To solve the above-mentioned problems, disclosed in an embodiment is a method for data processing, including obtaining streaming data for streaming media, determining status information of the streaming media based on the streaming data; determining corresponding sound effect data based on the status information of the streaming media; and including the sound effect data in the streaming data to obtain target streaming data, the target streaming data for transmitting to a target user.

To solve the above-mentioned problems, disclosed in an embodiment is a method for data processing, including providing streaming data for streaming media; transmitting comment data for the streaming data to determine corresponding sound effect data based on the comment data and status information of the streaming media, and including the sound effect data in subsequent streaming data, the status information of the streaming media determined based on the subsequent streaming data; and receiving the streaming data including the sound effect data, and playing the streaming data.

To solve the above-mentioned problems, disclosed in an embodiment is a method for data processing, including providing streaming data for streaming media to a target user; receiving comment data from the target user for the streaming data; determining corresponding sound effect data based on the comment data and status information of the streaming media, the status information of the streaming media determined based on subsequent streaming data; and including the sound effect data in the subsequent streaming data to obtain target streaming data, and transmitting the target streaming data to the target user.

To solve the above-mentioned problems, disclosed in an embodiment is an apparatus for data processing, including a streaming media status obtaining module configured to obtain streaming data for streaming media and determine status information of the streaming media based on the streaming data; a sound effect data obtaining module configured to determine corresponding sound effect data based on the status information of the streaming media; and a streaming data synthesis module configured to include the sound effect data in the streaming data to obtain target streaming data, the target streaming data for transmitting to a target user.

To solve the above-mentioned problems, disclosed in an embodiment is an apparatus for data processing, including a streaming data obtaining module configured to provide streaming data for streaming media; a comment data output module configured to transmit comment data for the streaming data to determine corresponding sound effect data based on the comment data and status information of the streaming media, and include the sound effect data in subsequent streaming data, the status information of the streaming media determined based on the subsequent streaming data; and a streaming data receiving module configured to receive the streaming data including the sound effect data and play the streaming data.

To solve the above-mentioned problems, disclosed in an embodiment is an apparatus for data processing, including a streaming data provision module configured to provide streaming data for streaming media to a target user; a comment data receiving module configured to receive comment data from the target user for the streaming data; a sound effect data determination module configured to determine corresponding sound effect data based on the comment data and status information of the streaming media, the status information of the streaming media determined based on subsequent streaming data; and a sound effect data including module configured to include the sound effect data in the subsequent streaming data to obtain target streaming data, and transmit the target streaming data to the target user.

To solve the above-mentioned problems, disclosed in an embodiment is an electronic device, including a processor, and a memory, having executable code stored thereon, wherein when executed, the executable code causes the processor to perform the method according to one or a plurality of the above-mentioned embodiments.

To solve the above-mentioned problems, disclosed in an embodiment is one or a plurality of machine-readable media, having executable code stored thereon, wherein when executed, the executable code causes a processor to perform the method according to one or a plurality of the above-mentioned embodiments.

Compared with existing approaches, the example embodiments have the following advantages.

In an embodiment, streaming data may be analyzed to obtain status information of streaming media of a presenter; then sound effect data matching a streaming media status of the presenter is determined based on the status information of the streaming media, the sound effect data is included in the streaming data to obtain target streaming data; and then the target streaming data is transmitted to a target user. In an embodiment, recognition is performed on the status of the presenter in the streaming data to obtain, via screening, a sound effect matching the streaming media status of the presenter, and the sound effect is included in the streaming data. The presenter can include corresponding sound effect data in the streaming data without searching a large amount of sound effect data for the corresponding sound effect data, thereby facilitating the operation of the presenter.

### BRIEF DESCRIPTION OF THE DRAWINGS

FIG. 1 is a block diagram illustrating a system for data processing according to some of the example embodiments.

FIG. 2A is a flow diagram illustrating a method for data processing according to some of the example embodiments.

FIG. 2B is a block diagram of a sound effect recommendation engine according to some of the example embodiments.

FIG. 3 is a flow diagram illustrating a method for data processing according to some of the example embodiments.

FIG. 4 is a flow diagram illustrating a method for data processing according to some of the example embodiments.

FIG. 5 is a flow diagram illustrating a method for data processing according to some of the example embodiments.

FIG. 6 is a block diagram of an apparatus for data processing according to some of the example embodiments.

FIG. 7 is a block diagram of an apparatus for data processing according to some of the example embodiments.

FIG. 8 is a block diagram of an apparatus for data processing according to some of the example embodiments.

FIG. 9 is a block diagram of an apparatus according to some of the example embodiments.

### DETAILED DESCRIPTION

To further describe the above-mentioned objectives, features, and advantages of the present application, the example embodiments are further described below in detail in combination with the accompanying figures.

The example embodiments are applicable to the field of live streaming. Live streaming refers to a broadcasting method in which post-synthesis and broadcasting of a radio or television program are simultaneously performed. Depending on a broadcasting scenario, the live streaming may include on-the-spot live streaming (such as network live streaming), live streaming from a broadcasting or television studio, and other forms. The example embodiments are applicable to the field of live streaming, such as to the scenario of network live streaming.

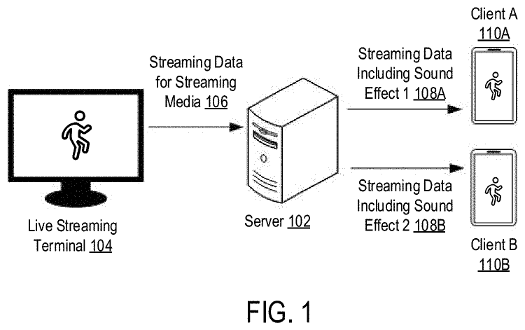

FIG. 1 is a block diagram illustrating a system for data processing according to some of the example embodiments.

As shown in FIG. 1, a method for data processing according to some of the example embodiments may be performed by a processing terminal. In an embodiment, the processing terminal may be a server for storing and forwarding streaming data. In another embodiment, the processing terminal may also be a live streaming terminal for acquiring streaming data. In another embodiment, the processing terminal may also be a client for outputting streaming data.

In another embodiment, for example, the processing terminal can be a server 102. A live streaming terminal 104 may acquire streaming data 106 and transmit the streaming data 106 to server 102. Server 102 may perform recognition on a status of a presenter in the streaming data 106. The server can then include sound effect data in the streaming data based on the status. Finally, the server can then transmit the streaming data, including the sound effect 108A, 108B, to a client (e.g., client 110A or client 110B) of a user viewing the streaming media.

The sound effects are also be referred to as audio effects. Sound effects may be artificially produced or can be enhancements to recorded sounds. Sound effects can be used to augment the sound processing of graphics or other content in a movie, video game, music, or other media. For example, the sound effects may include clapping, cheering, screaming, animal, nature, musical instrument sound effects, etc. In an embodiment, the sound effect data can be included in the streaming data, thereby enhancing the atmosphere of the streaming media.

Specifically, the streaming data of the presenter may be obtained. Status information of the streaming media of the presenter may be determined based on the streaming data. The streaming data of the presenter may include a streaming video of the presenter. The status information of the streaming media may include live streaming atmosphere information and live streaming mood information. After the status information of the streaming media is determined, corresponding sound effect data may be determined based on the status information of the streaming media of the presenter and preference information of a target user. The sound effect data may be included in the streaming data to obtain target streaming data. The target streaming data can then be transmitted to the target user.

For example, recognition may be performed on a facial expression, body movement, and/or voice data of the user in the streaming data to determine that a live streaming mood of the presenter is happy. Preference information of the target user for the sound effect can be determined based on the historical viewing behavior of the target user. Then, it can be determined that a cheering sound effect should be used as the sound effect data. The cheering sound effect can then be included in the streaming data to obtain the target streaming data.

In an embodiment, recognition is performed on the streaming data to determine the status information of the streaming media. Sound effect data matching the status information of the streaming media can then be determined based on the status information of the streaming media. The determined sound effect data can then be included in the streaming data. The presenter can include the sound effect data in the streaming data without searching a large amount of sound effect data for the sound effect data, thereby easing the operations of the presenter.

In addition to the streaming video of the presenter, the streaming data of the presenter may further include attribute information, status preference information, interaction habits, a voiceprint, a sound channel attribute, or other associated information of the presenter (or combination thereof). For example, the streaming data of the presenter may include attribute information of the presenter and the age, the gender, or other information of the presenter. From this data, the status information of the streaming media can be ascertained based on the age, gender, and streaming video of the presenter. As another example, the streaming data of the presenter may include an interaction habit of the presenter. The processing terminal may configure different weight values for different streaming media states based on the interaction habit of the presenter to determine the status information of the streaming media based on the weight value and the streaming video. As another example, the streaming data of the presenter may include the voiceprint of the presenter. The processing terminal may extract audio related to the presenter from the streaming video based on the voiceprint of the presenter. The processing terminal may further perform recognition on the audio comprising the voiceprint of the presenter to determine the status information of the streaming media. As another example, when the position of the presenter changes, the streaming media status may change accordingly. For example, a status in which the presenter stands up and performs a talent show and a status in which the presenter sits in a seat and chats may correspond to different streaming media status recognition methods. Therefore, the streaming data may further include a sound channel attribute. The processing terminal may determine the position of the presenter based on a sound channel attribute of the audio in the streaming video to further obtain the streaming media status of the presenter via recognition and based on the position and a corresponding recognition method.

After the status information of the streaming media is determined, corresponding sound effect data may be determined based on the status information of the streaming media and user information (such as preference information) of the user viewing the streaming media. The user information may include a preference of the user for each piece of the sound effect data and may further include level information of the user and a registration time, use frequency, average daily use duration, and other information of the user to further determine the corresponding sound effect data. For example, for a user having a low use frequency and a user having a high use frequency, the user having high use frequency is relatively more engaged with a product. Therefore, the user information may include a registration time, use frequency, average daily use duration, and other information of the user so that the processing terminal can determine the engagement of a user based on the registration time, the use frequency, the average daily use duration, and other information of the user. Therefore, more services are provided to a user having relatively high engagement to determine the quality of service based on feedback from the client having high engagement. As another example, since the sound effect data may be classified into different levels, the user information may further include the level information of the user, so that sound effect data at different levels can be provided to users at different levels, thereby improving a sense of participation of the user in the live streaming. In an embodiment, the corresponding sound effect data may also be determined based on the comment data of the user for the streaming media. For example, the processing terminal may pre-configure a plurality of keyword groups corresponding to different sound effects. The processing terminal may obtain comment data of the user for the streaming data, extract a keyword in the comment data, and further determine, based on the keyword, a keyword group to which the keyword belongs to determine the corresponding sound effect data and include the sound effect data in the streaming data. In an embodiment, the sound effect data may further be classified into different types, such as a paid sound effect and a free sound effect, to provide corresponding sound effect services for users of different types. In an embodiment, the sound effect data may further include sound channel information to simulate a stereo sound effect via a time delay between different sound channels.

In an embodiment, the processing terminal can act as a bridge between the live streaming terminal 104 of the presenter and the client device of the user (e.g., client 110A or client 110B). The processing terminal may receive the streaming data of the live streaming terminal 104 and transmit the streaming data to the client (e.g., client 110A or client 110B). The processing terminal may provide a streaming data display page to the user. The streaming data display page may include a streaming video display control, a streaming media comment obtaining control, a streaming media bullet comment display control, etc. The user viewing the streaming media may upload comment data by triggering a streaming media comment obtaining page. The processing terminal may receive feedback information (e.g., comment data) returned by the client to the live streaming terminal. The processing terminal may transmit the feedback information to the live streaming terminal (or other clients). In an embodiment, feedback information of the user within a time period may be acquired to analyze the feedback information of the user to determine the preference information of the user. The feedback information of the user may include streaming media content viewed by the user and information such as an evaluation of the user on the streaming media content. For example, the processing terminal may determine, based on the streaming media content viewed by the user, whether the user has switched from streaming media content including a sound effect to another streaming media content not including any sound effect. Further, it can be determined whether the user likes the sound effect to determine whether to continue to include a sound effect in subsequent streaming data. The client, according to the example embodiments, can be a terminal device, such as a computer terminal, a mobile phone terminal, etc., and may also be an Internet-of-Things device such as a virtual reality (VR) device (such as VR glasses) applying virtual reality technology, an augmented reality (AR) device applying augmented reality, etc. The processing terminal may transmit, to the VR device or the AR device, data including sound effect data (and/or a special effect applied to an image) and may output the data via the VR device or the AR device. In addition, the processing terminal may receive feedback information such as a body movement of the user, a facial expression of the user, or other data returned by the VR device or the AR device (or other devices) to determine whether the user is satisfied with the sound effect data or the special effect.

The example embodiments may be applied to the scenario of live streaming of a network presenter, and may also be applied to the scenarios of on-demand playing of a live streaming video, live streaming of a concert, recorded streaming of a concert, live streaming of a film and television program, on-demand playing of a film and television program, live streaming of a variety show, on-demand playing of a variety show, etc. to include, in a video, a sound effect suitable for an object status to improve user experience. For example, the example embodiments may be applied to the scenario of on-demand playing of a live streaming video. The processing terminal may determine corresponding sound effect data based on a streaming media status of a presenter in the live streaming video and user information of a user viewing the streaming media, may include the sound effect data in the live streaming video to form target streaming data, and may transmit the target streaming data to the client.

In an embodiment, data processing may be performed on the streaming data, and a sound effect suitable for an object status in data including audio data and/or image data may also be included in the data to obtain edited data. For example, recognition may be performed on data of a pet video, a status of a pet may be obtained via recognition, and a sound effect corresponding to this status may be included. As another example, recognition may also be performed on a scenery object (a tree, a river, etc.) in a captured scenery video, and a corresponding sound effect may be included. For example, a wind sound effect may be included for a tree in a swaying state, or a flowing water sound effect may be included for river water in a flowing state.

The method for data processing, according to the example embodiments, may be performed via a processing terminal. The processing terminal may be a server for storing and forwarding streaming data, a live streaming terminal for acquiring streaming data, or a client for outputting streaming data. In an embodiment, methods for data processing are described by using an example in which the processing terminal is a server. However, the example embodiments are not limited to such an implementation.

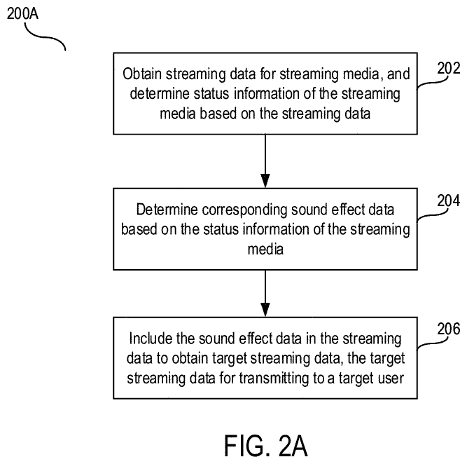

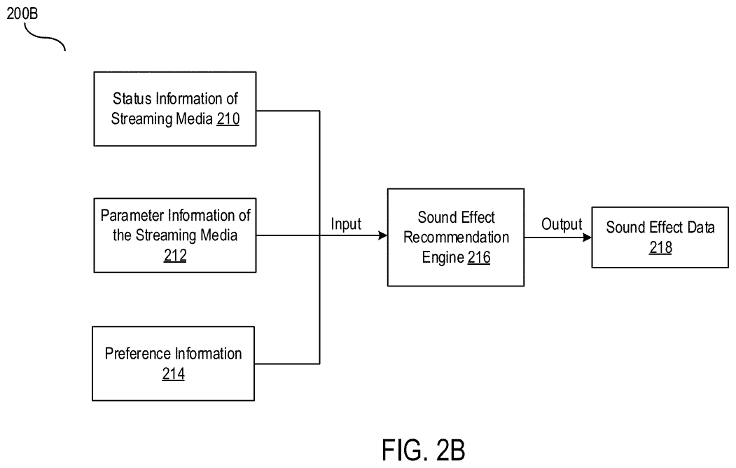

FIG. 2A is a flow diagram illustrating a method 200A for data processing according to some of the example embodiments. Specifically, as illustrated, method 200A for data processing can include the following steps.

In step 202, the method 200A can include obtaining streaming data for streaming media and determining the status information of the streaming media based on the streaming data.

The streaming data may be streaming data in scenarios such as product recommendations, talent shows, interactive entertainment, etc. The status information may be configured based on an object in the data to be processed. For example, when the data to be processed is streaming data, the status information of the streaming media may be a live streaming atmosphere of a presenter, a live streaming mood of the presenter, or other information.

The live streaming mood and the live streaming atmosphere may be classified based on categories. Corresponding to different types of moods, corresponding sound effect data may be determined, and the sound effect data can then be included in the streaming data. For example, live streaming moods may include positive moods, negative moods, or other moods. Positive moods may include excitement, happiness, warmth, or enthusiasm. Negative moods may include anger, depression, sadness, fear, or oppression. Other moods may include surprise, embarrassment, or calmness. For positive moods, sound effect data of relaxation and pleasure categories may be determined and included in the streaming data. For negative moods, sound effect data of sadness and depression categories may be determined and included in the streaming data. In the case where the data to be processed is pet video data to be edited, the status information may be behavior and movement information of a pet, such as a running movement of the pet. In the case where the data to be processed is scenery video data to be edited, the status information may be movement information of a scenery object, such as swaying of a tree caused by wind, flowing of river water, etc. In an embodiment, the streaming data of the streaming media may be obtained, and live streaming atmosphere information of the presenter and live streaming mood information of the presenter may be obtained from the streaming data and may be used as the status information of the streaming media of the presenter.

During a live streaming process performed by the presenter, corresponding to different scenarios, it is possible that no sound effect needs to be included in some scenarios. Therefore, an identifier of scenario information may be included in the acquired streaming data to determine, based on the identifier, whether to perform recognition on a streaming media status. Specifically, in an embodiment, determining status information of the streaming media based on the streaming data can include obtaining scenario information in the streaming data and determining the status information of the streaming media based on the scenario information and the streaming data. In an optional embodiment, the live streaming terminal may include a corresponding scenario identifier in the acquired streaming data, and the processing terminal may extract the scenario identifier from the streaming data to determine the scenario information. Specifically, during the acquisition of the streaming data, the live streaming terminal acquires a current live streaming scenario of the live streaming terminal, generates a corresponding scenario identifier, includes the scenario identifier in the acquired streaming data, and transmits, to the processing terminal, the streaming data including the scenario identifier. After receiving the streaming data, the processing terminal extracts the scenario identifier from the streaming data to determine a corresponding scenario. The live streaming terminal may determine a current live streaming scenario based on an operation status of a currently running application. For example, for a singer, in the case where an accompaniment application is run, a scenario in which the presenter is performing a talent show may be determined, and a corresponding scenario identifier may be generated. In the case where the accompaniment application is not run, it is possible to determine that the presenter is in another scenario. In another embodiment, after receiving the streaming data, the processing terminal may perform pre-recognition on audio data and image data to determine the scenario information. For different types of presenters, different recognition methods may be used. For example, for a game presenter, it is possible to determine, via recognition, whether the streaming data is a game interface to determine scenario information of the streaming data.

During analysis of the streaming data, the processing terminal may perform recognition on the audio data and/or the image data in the streaming data to obtain the status information of the streaming media. Specifically, in an embodiment, the determining status information of the streaming media based on the streaming data includes at least one of the following steps: analyzing audio data in the streaming data to determine status data of the streaming media or analyzing image data in the streaming data to determine status data of the streaming media. The streaming data may include at least one of the audio data and the image data. In an embodiment, an analysis may be performed on at least one of the audio data and the image data to obtain the status information of the streaming media.

The status data of the streaming media may include the live streaming mood information and the live streaming atmosphere information of the presenter. The processing terminal may extract a voice feature in the audio data and may determine a live streaming mood and a live streaming atmosphere of the presenter based on the voice feature. Specifically, in one embodiment, analyzing audio data in the streaming data to determine the status data of the streaming media includes performing recognition on the audio data to obtain voice feature information and analyzing the voice feature information to determine the status data of the streaming media. The voice feature information may include at least one of a sound quality feature, a prosody feature, and a frequency spectrum feature. The sound quality can include aspects such as volume, pitch, and timbre (or a combination thereof). The volume of the sound can be represented as the intensity and the amplitude of audio. A tone of the sound is also referred to as pitch and can be represented as the frequency of the audio or the number of changes per second of the audio. The timbre of the sound is an overtone of the audio. The prosodic feature is also referred to as a super-sound quality feature or suprasegmental feature. The prosodic feature is a phonological structure of language and is closely related to other linguistic structures such as syntax, text structure, information structure, etc. The frequency spectrum feature refers to frequency spectrum data obtained by performing frequency spectrum conversion on the audio data. The processing terminal may extract the audio data and perform recognition thereon to obtain the voice feature information, may determine the live streaming mood and the live streaming atmosphere of the presenter based on the voice feature information, for use as the status data of the streaming media.

During analysis of the image data in the streaming data, recognition may be performed on the facial expression and/or the body movement of the presenter in the image data to obtain the status data of the streaming media. Specifically, in an embodiment, analyzing image data in the streaming data to determine status data of the streaming media can include analyzing a facial feature and/or body movement information of a character in the image data to determine the status data of the streaming media. Mood expressions corresponding to different mood categories and mood movements corresponding to different mood categories may be pre-configured in the processing terminal. The processing terminal may analyze the facial feature of the presenter in the streaming data to determine a mood expression matching the facial feature, may analyze the body movement of the presenter to determine a mood movement included therein and may determine, based on the mood expression matching the facial feature and the mood movement included in the body movement, a mood corresponding to the presenter. For example, if it is determined, via recognition, that a facial feature of the user matches an angry expression and that a body movement of the user includes a fisting movement, then it is possible to determine that the mood corresponds to the presenter is an angry mood.

In step 204, method 200 can include determining corresponding sound effect data based on the status information of the streaming media.

In the case where the status data of the streaming media includes the live streaming mood information, method 200 can determine corresponding sound effect data based on a category to which the live streaming mood information belongs. In an embodiment, method 200 can determine corresponding sound effect data based on the streaming media status of the presenter, and the sound effect data may further be included accordingly based on different preferences of users viewing the streaming media. Specifically, in an embodiment, the determining sound effect data based on the status information of the streaming media can include determining the corresponding sound effect data based on the status information of the streaming media and preference information of a target user viewing the streaming media. Preference data refers to the degrees of interest of the user in different sound effects. The processing terminal may recommend, based on the status information of the streaming media of the presenter and degrees of preference of the user viewing the streaming media for different sound effect data, to the user a sound effect meeting the preference of the user viewing the streaming media.

For example, a first user may have a high degree of interest in a first type of cheering sound effects but a low degree of interest in a second type of cheering sound effects. Conversely, a second user may have a low degree of interest in the first type of cheering sound effects but a high degree of interest in the second type of cheering sound effects. When it is determined, based on the status information of the streaming media, that the sound effect data belongs to a cheering category, the first type of cheering sound effects may be recommended to the first user, and the second type of cheering sound effects may be recommended to the second user.

The preference information of each user may be determined based on the historical viewing behavior of the user with respect to the streaming data. Specifically, in an embodiment, method 200 can further include obtaining the historical viewing behavior of the target user and determining the preference information of the target user based on the historical viewing behavior. The historical viewing behavior may include viewing duration for the streaming data, evaluation data for the streaming data, sharing and liking of the streaming data, and other behaviors. Users may be classified into different groups in the processing terminal. For example, users belonging to the same age group, having similar consumption levels, and viewing similar streaming media content may be configured to be in the same group. Users in a group may be classified to obtain a first set of users for including a first sound effect, a second set of users for including a second sound effect, and a third set of users for including no sound effect. The processing terminal may acquire the historical viewing behavior of users of different sets of users in the same group and may perform comparison and analysis to obtain the preference information of the target user.

A sound effect recommendation engine may be configured in the processing terminal. The status information of the streaming media of the presenter, the preference information of the target user viewing the streaming media, and parameter information of the streaming media pre-configured by the presenter for the streaming media are input into the sound effect recommendation engine to obtain the corresponding sound effect data. Specifically, in an embodiment, determining the corresponding sound effect data based on the status information of the streaming media and preference information of a target user viewing the streaming media includes inputting the status information of the streaming media, the preference information, and parameter information of the streaming media configured for the streaming media into a sound effect recommendation engine to obtain the corresponding sound effect data. The parameter information of the streaming media is used to describe the streaming media content. For example, the parameter information of the streaming media may include streaming media style information (such as an entertainment type) of the presenter and a streaming media type (such as a game type) to which the streaming media content belongs.

FIG. 2B is a block diagram of a sound effect recommendation engine according to some of the example embodiments. As shown in FIG. 2B, the sound effect recommendation engine may perform analysis based on the inputted data to obtain the corresponding sound effect data.

The sound effect recommendation engine 216 may be understood as an algorithm model using the inputted data and parameters of the sound effect recommendation engine to perform computations to obtain the sound effect data. The sound effect recommendation engine 216 may use the status information of the streaming media 210, the parameter information of the streaming media 212, and the preference information 214 as the inputted data and perform analysis to obtain the corresponding sound effect data 218. In addition, depending on the parameter information of the streaming media 212 of the presenter and/or the preference information 214 of the target user, the sound effect recommendation engine may also be configured with a plurality of sub-engines. The processing terminal may input the parameter information of the streaming media 212 and the preference information 214 of the target user into the sound effect recommendation engine 216, determine a corresponding sub-engine, and use the sub-engine to analyze the status information of the streaming media 210 to obtain the corresponding sound effect data 218.

Returning to FIG. 2A, after determining the corresponding sound effect data, method 200, in step 206, can include including the sound effect data in the streaming data to obtain target streaming data, the target streaming data for transmitting to the target user. For different users viewing the streaming media, the processing terminal may determine sound effect data corresponding to the user and include the sound effect data in the streaming data to obtain the target streaming data and may then transmit the target streaming data to a corresponding target user. Different target users may receive streaming data, including different sound effect data, thereby improving user experience.

In an embodiment, after the sound effect data is determined, the sound effect data may be directly included in the streaming data. Alternatively, after the sound effect data is determined, the determined sound effect data may be displayed to the presenter, and sound effect data selected by the presenter may be included in the streaming data based on a selection instruction of the presenter to the sound effect data. Specifically, in an embodiment, including the sound effect data in the streaming data to obtain target streaming data can include including the sound effect data in display information for displaying and receiving a selection instruction for the sound effect data in the display information. Next, method 200 can include selected sound effect data in the streaming data to obtain the target streaming data. The display information can be a display box or a similar user interface element. After the sound effect data is determined, the processing terminal may include the sound effect data in the display box and may transmit the display box to the presenter at the live streaming terminal. The presenter may generate a selection instruction by clicking the sound effect data in the display box and may transmit the selection instruction to the processing terminal. After receiving the selection instruction, the processing terminal includes the corresponding sound effect data in the streaming data to obtain the target streaming data and transmits the target streaming data to the target user.

After including the sound effect data in the streaming data and transmitting the streaming data to the target user, the processing terminal may further determine, based on viewing behavior of the target user with respect to the streaming data, including the sound effect data, a degree of interest of the user in the streaming data including the sound effect data to adjust the sound effect recommendation engine. Specifically, in an embodiment, method 200 can further include acquiring the target viewing behavior of the target user and adjusting the sound effect recommendation engine based on the target viewing behavior. The viewing behavior of the target user may include comment data for the streaming data, viewing duration for the streaming data, sharing and liking of the streaming data, and other behaviors. Within a time period after the streaming data, including the sound effect data, is transmitted to the target user, the processing terminal may monitor the behavior of the target user to determine whether the viewing behavior of the target user is positive or negative to adjust the sound effect recommendation engine.

To determine whether the viewing behavior of the target user is positive behavior or negative behavior, in an embodiment, different recommendation schemes may be adopted for different users of a user group having the same preference, and comparison and analysis may be performed on the feedback of different users in the group on different sound effect data to determine an influence of the sound effect data on the viewing behavior of the target user to adjust the sound effect recommendation engine. Specifically, in an embodiment, adjusting parameters of the sound effect recommendation engine based on the target viewing behavior can include determining, based on the preference information of the target user, a user group to which the target user belongs; obtaining another viewing behavior of another user in the user group; and adjusting the sound effect recommendation engine based on the target viewing behavior and the other viewing behavior. The processing terminal may pre-classify a user into a corresponding user group based on the preference information of the user. During including of the sound effect data in the streaming data, the processing terminal may include sound effect data in streaming data transmitted to a part of users in the user group, may include no sound effect data in streaming data transmitted to other users in the user group, may then obtain viewing behavior of each user in the user group, and may analyze a difference between viewing behavior involving including of sound effect data and viewing behavior not involving including of sound effect data to determine whether the sound effect data has a positive influence or a negative influence on the viewing behavior of the user, to adjust the sound effect recommendation engine. In an embodiment, the viewing behavior of the user for the streaming data, including the sound effect data, may be analyzed to adjust the sound effect recommendation engine to improve the accuracy of the sound effect recommendation engine.

In an embodiment, streaming data may be analyzed to obtain status information of streaming media of a presenter; then corresponding sound effect data is determined based on the status information of the streaming media, the sound effect data is included in the streaming data to obtain target streaming data; and the target streaming data is transmitted to a target user. In an embodiment, recognition is performed on the status of the presenter in the streaming data to obtain, via screening, a sound effect matching the status of the presenter, and the sound effect is included in the streaming data. The presenter can include corresponding sound effect data in the streaming data without searching a large amount of sound effect data for the corresponding sound effect data, thereby facilitating the operation of the presenter.

On the basis of the above-mentioned embodiments, the present application further provides methods for sound effect data processing. In some embodiments, the following methods can be performed by a processing terminal.

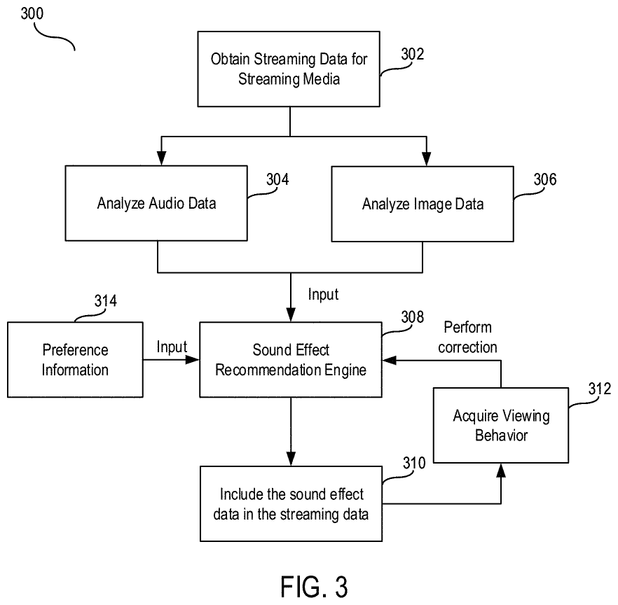

FIG. 3 is a flow diagram illustrating a method 300 for data processing according to some of the example embodiments. As illustrated, method 300 includes the following steps.

In step 302, method 300 can include obtaining streaming data for streaming media.

In step 304, method 300 can include analyzing audio data in the streaming data to determine the status data of the streaming media. In an embodiment, analyzing audio data in the streaming data to determine status data of the streaming media can include performing recognition on the audio data to obtain voice feature information and analyzing the voice feature information to determine the status data of the streaming media.

In step 306, method 300 can include analyzing image data in the streaming data to determine the status data of the streaming media. In an embodiment, analyzing image data in the streaming data to determine status data of the streaming media can include analyzing a facial feature and body movement information of a character in the image data to determine the status data of the streaming media.

In step 308, method 300 can include inputting the status information of the streaming media, the preference information (314), and parameter information of the streaming media configured for the streaming media into a sound effect recommendation engine to obtain the corresponding sound effect data. In an embodiment, method 300 further can include obtaining historical viewing behavior of the target user; and determining the preference information of the target user based on the historical viewing behavior.

In step 310, method 300 can include including the sound effect data in the streaming data to obtain target streaming data, the target streaming data for transmitting to a target user. In an embodiment, including the sound effect data in the streaming data to obtain target streaming data can include including the sound effect data in display information for displaying and receiving a selection instruction for the sound effect data in the display information. In some embodiments, method 300 can further include including selected sound effect data in the streaming data to obtain the target streaming data.

In step 312, method 300 can include acquiring the target viewing behavior of the target user to adjust the sound effect recommendation engine based on the target viewing behavior. In an embodiment, adjusting the sound effect recommendation engine based on the target viewing behavior can include determining, based on the preference information of the target user, a user group to which the target user belongs; obtaining another viewing behavior of another user in the user group; and adjusting the sound effect recommendation engine based on the target viewing behavior and the other viewing behavior.

In an embodiment, audio data and image data in streaming data may be analyzed to obtain status information of streaming media of a presenter. Then, the status information of the streaming media, pre-configured parameter information of the streaming media, and preference information of a target user viewing the streaming media may be inputted into a sound effect recommendation engine to output corresponding sound effect data. In an embodiment, the sound effect data may be included in the streaming data to obtain target streaming data, and the target streaming data may be transmitted to the target user. Then, the viewing behavior of the target user for the streaming data, including the sound effect data, may be acquired, and the sound effect recommendation engine may be adjusted based on the viewing behavior, thereby improving the accuracy of the sound effect recommendation engine. In an embodiment, recognition is performed on the status of the presenter in the streaming data to obtain, via screening, a sound effect matching the status of the presenter, and the sound effect is included in the streaming data. The presenter can include corresponding sound effect data in the streaming data without searching a large amount of sound effect data for the corresponding sound effect data, thereby facilitating the operation of the presenter.

On the basis of the above-mentioned embodiments, further provided in the present application are methods for data processing applied to a processing terminal. The processing terminal may be a client of a user viewing streaming media. In the methods for data processing, according to some of the example embodiments, a comment of the user viewing the streaming media may be used to determine sound effect data matching the comment of the user viewing the streaming media, thereby improving user experience.

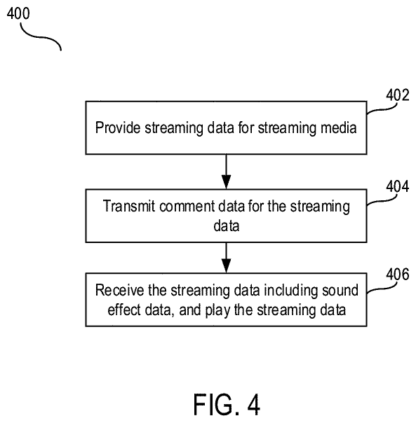

FIG. 4 is a flow diagram illustrating a method 400 for data processing according to some of the example embodiments. As illustrated, method 400 includes the following steps.

In step 402, method 400 can include providing streaming data for streaming media.

In step 404, method 400 can include transmitting comment data for the streaming data to determine corresponding sound effect data based on the comment data and status information of the streaming media, and the sound effect data is included in subsequent streaming data, and the status information of the streaming media is determined based on the subsequent streaming data.

In step 406, method 400 can include receiving the streaming data, including the sound effect data, and playing the streaming data. Specific implementations of step 406 are similar to previously described example embodiments, and these details are not repeated herein.

In an embodiment, the processing terminal may provide streaming data for streaming media. A user viewing the streaming media at the processing terminal may input comment data for the streaming data and transmit the comment data to a server. After receiving the comment data, the server may perform recognition on status information of streaming media of a presenter in the subsequent streaming data. The server may then use a combination of the status information of the streaming media and the comment data to determine corresponding sound effect data. The server may then include the sound effect data in the subsequent streaming data and may transmit the streaming data to the user viewing the streaming media at the processing terminal. After receiving, from the server, the streaming data, including the sound effect data, the processing terminal outputs the data. In an embodiment, a combination of the comment of the user viewing the streaming media on the streaming data and a streaming media status of the presenter may be used to determine a sound effect, thereby providing a more suitable sound effect for the user viewing the streaming media and improving the user experience of the user viewing the streaming media.

For example, a first viewing user and second viewing user can view streaming data of the same streaming media. The first viewing user provides positive comment data on the streaming data, such as “great,” while the second viewing user provides negative comment data on the streaming data, such as “disappointing.” The processing terminal may obtain the comment data of the first viewing user, may use a combination of the comment data and the status information of the streaming media of the presenter in the subsequent streaming data to include a sound effect “applause” in the subsequent streaming data, and may transmit the sound effect to the first viewing user. The processing terminal may obtain the comment data of the second viewing user, may use a combination of the comment data and the status information of the streaming media of the presenter in the subsequent streaming data to include a sound effect “catcall” in the subsequent streaming data, and may transmit the streaming data to the second viewing user. In an embodiment, a combination of the comment of the user viewing the streaming media and the streaming media status of the presenter may be used to recommend a more suitable sound effect for the user viewing the streaming media, thereby improving the viewing experience.

On the basis of the above-mentioned embodiments, further provided in the present application are methods for data processing applied to a processing terminal. The processing terminal may be a server for data relay and storage. In the methods for data processing, according to some of the example embodiments, a comment of the user viewing the streaming media may be used to determine sound effect data matching the comment of the user viewing the streaming media, thereby improving user experience.

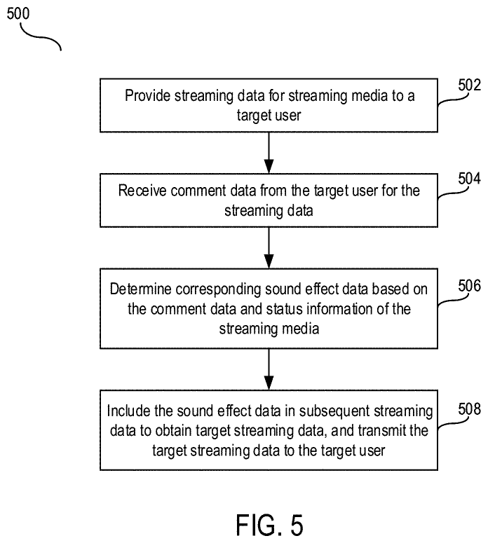

FIG. 5 is a flow diagram illustrating a method 500 for data processing according to some of the example embodiments. As illustrated, method 500 includes the following steps.

In step 502, method 500 can include providing streaming data for streaming media to a target user.

In step 504, method 500 can include receiving comment data from the target user for the streaming data.

In step 506, method 500 can include determining corresponding sound effect data based on the comment data and status information of the streaming media, and the status information of the streaming media is determined based on subsequent streaming data.

In step 508, method 500 can include including the sound effect data in the subsequent streaming data to obtain target streaming data and transmitting the target streaming data.

In an embodiment, the processing terminal may provide streaming data for streaming media to a client of the target user viewing the streaming media. The target user at the client may input comment data for the streaming data and transmit the comment data to the processing terminal. After receiving the comment data, the processing terminal may perform recognition on status information of streaming media of a presenter in the subsequent streaming data, may then use a combination of the status information of the streaming media and the comment data to determine corresponding sound effect data, may include the sound effect data in the subsequent streaming data, and may transmit the streaming data to the target user at the client. In an embodiment, a combination of the comment of the target user viewing the streaming media on the streaming data and a streaming media status of the presenter may be used to determine a sound effect, thereby providing a more suitable sound effect for the target user viewing the streaming media and improving the user experience of the target user viewing the streaming media.

The aforementioned method embodiments are expressed as a combination of a series of actions for ease of description. Those skilled in the art will recognize that the example embodiments are not limited by the described order of actions as some steps may, in accordance with the example embodiments, be carried out in other orders or simultaneously. Secondly, those skilled in the art should also appreciate that the embodiments described in the specification all belong to the example embodiments and that the involved actions are not necessarily required by the example embodiments.

On the basis of the above-mentioned embodiments, the present application further provides apparatuses for data processing.

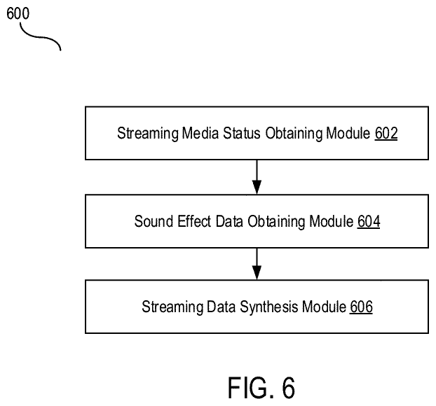

FIG. 6 is a block diagram of an apparatus 600 for data processing according to some of the example embodiments.

The apparatus 600 can include a streaming media status obtaining module 602 configured to obtain streaming data for streaming media and determine status information of the streaming media based on the streaming data. The apparatus 600 can further include a sound effect data obtaining module 604 configured to determine corresponding sound effect data based on the status information of the streaming media. The apparatus 600 can further include a streaming data synthesis module 606 configured to include the sound effect data in the streaming data to obtain target streaming data, the target streaming data for transmitting to a target user.

In summary, in an embodiment, streaming data may be analyzed to obtain status information of streaming media of a presenter. Then, sound effect data matching a streaming media status of the presenter is determined based on the status information of the streaming media, the sound effect data is included in the streaming data to obtain target streaming data. Then, the target streaming data is transmitted to a target user. In an embodiment, recognition is performed on the status of the presenter in the streaming data to obtain, via screening, a sound effect matching the status of the presenter, and the sound effect is included in the streaming data. The presenter can include corresponding sound effect data in the streaming data without searching a large amount of sound effect data for the corresponding sound effect data, thereby facilitating the operation of the presenter.

On the basis of the above-mentioned embodiments, the present application further provides apparatuses for data processing. The apparatus may specifically include the following modules.

The apparatus 600 can include a streaming data access module configured to obtain streaming data for streaming media. In some embodiments, the apparatus 600 can include an audio data analysis module configured to analyze audio data in the streaming data to determine the status data of the streaming media. In an embodiment, the audio data analysis module specifically can include performing recognition on the audio data to obtain voice feature information and analyzing the voice feature information to determine the status data of the streaming media.

In some embodiments, the apparatus 600 can include an image data analysis module configured to analyze image data in the streaming data to determine the status data of the streaming media. In an embodiment, the image data analysis module specifically can include analyzing a facial feature and body movement information of a character in the image data to determine the status data of the streaming media.

In some embodiments, the apparatus 600 can include a data input processing module configured to input the status information of the streaming media, the preference information, and parameter information of the streaming media configured for the streaming media into a sound effect recommendation engine to obtain the corresponding sound effect data. In an embodiment, the apparatus 600 further can include a preference determination module configured to obtain the historical viewing behavior of the target user and determine the preference information of the target user based on the historical viewing behavior.

In some embodiments, the apparatus 600 can include a data synthesis processing module configured to include the sound effect data in the streaming data to obtain target streaming data, the target streaming data for transmitting to a target user. In an embodiment, the data synthesis processing module specifically can include including the sound effect data in display information for displaying; and receiving a selection instruction for the sound effect data in the display information and including selected sound effect data in the streaming data to obtain the target streaming data.

In some embodiments, apparatus 600 can include an adjustment processing module configured to acquire the target viewing behavior of the target user to adjust the sound effect recommendation engine based on the target viewing behavior. In an embodiment, the adjustment processing module specifically can include determining, based on the preference information of the target user, a user group to which the target user belongs; obtaining another viewing behavior of another user in the user group and adjusting the sound effect recommendation engine based on the target viewing behavior and the other viewing behavior.

In an embodiment, audio data and image data in streaming data may be analyzed to obtain status information of streaming media of a presenter; then the status information of the streaming media, pre-configured parameter information of the streaming media, and preference information of a target user viewing the streaming media may be inputted into a sound effect recommendation engine to output corresponding sound effect data; the sound effect data may be included in the streaming data to obtain target streaming data, and the target streaming data may be transmitted to the target user. Then, the viewing behavior of the target user for the streaming data, including the sound effect data, may be acquired, and the sound effect recommendation engine may be adjusted based on the viewing behavior, thereby improving the accuracy of the sound effect recommendation engine. In an embodiment, recognition is performed on the status of the presenter in the streaming data to obtain, via screening, a sound effect matching the status of the presenter, and the sound effect is included in the streaming data. The presenter can include corresponding sound effect data in the streaming data without searching a large amount of sound effect data for the corresponding sound effect data, thereby facilitating the operation of the presenter.

On the basis of the above-mentioned embodiments, the present application further provides apparatuses for data processing.

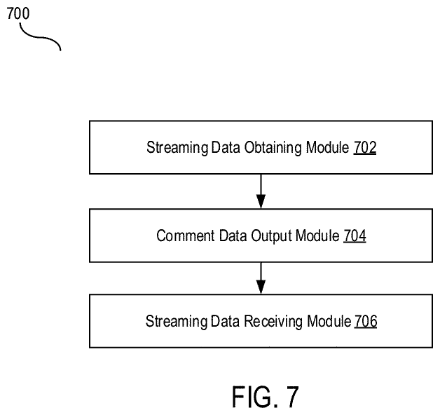

FIG. 7 is a block diagram of an apparatus 700 for data processing according to some of the example embodiments. Referring to FIG. 7, apparatus 700 may specifically include the following modules.

The apparatus 700 can include a streaming data obtaining module 702 configured to provide streaming data for streaming media. The apparatus 700 can include a comment data output module 704 configured to transmit comment data for the streaming data to determine corresponding sound effect data based on the comment data and status information of the streaming media and include the sound effect data in subsequent streaming data, the status information of the streaming media is determined based on the subsequent streaming data. The apparatus 700 can include a streaming data receiving module 706 configured to receive the streaming data, including the sound effect data, and play the streaming data.

In summary, in an embodiment, the processing terminal may provide streaming data for streaming media. A user viewing the streaming media at the processing terminal may input comment data for the streaming data and transmit the comment data to a server. After receiving the comment data, the server may perform recognition on status information of streaming media of a presenter in the subsequent streaming data, may then use a combination of the status information of the streaming media and the comment data to determine corresponding sound effect data, may include the sound effect data in the subsequent streaming data, and may transmit the streaming data to the user viewing the streaming media at the processing terminal. After receiving, from the server, the streaming data, including the sound effect data, the processing terminal outputs the data. In an embodiment, a combination of the comment of the user viewing the streaming media on the streaming data and a streaming media status of the presenter may be used to determine a sound effect, thereby providing a more suitable sound effect for the user viewing the streaming media and improving the user experience of the user viewing the streaming media.

On the basis of the above-mentioned embodiments, the present application further provides apparatuses for data processing.

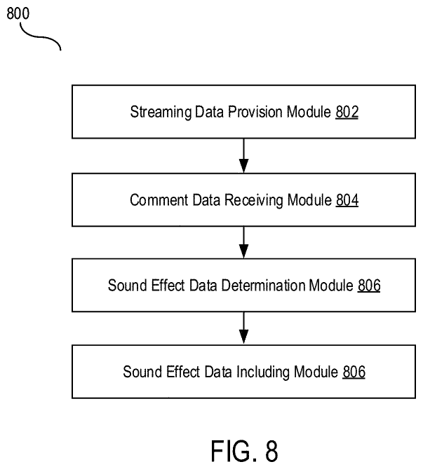

FIG. 8 is a block diagram of an apparatus 800 for data processing according to some of the example embodiments. Referring to FIG. 8, apparatus 800 may specifically include the following modules.

The apparatus 800 can include a streaming data provision module 802 configured to provide streaming data for streaming media to a target user. The apparatus 800 can include a comment data receiving module 804 configured to receive comment data from the target user for the streaming data. The apparatus 800 can include a sound effect data determination module 806 configured to determine corresponding sound effect data based on the comment data and status information of the streaming media, the status information of the streaming media is determined based on subsequent streaming data. The apparatus 800 can include a sound effect data including module 808 configured to include the sound effect data in the subsequent streaming data to obtain target streaming data and transmit the target streaming data to the target user.

In summary, in an embodiment, the processing terminal may provide streaming data for streaming media to a client of the target user viewing the streaming media. The target user at the client may input comment data for the streaming data and transmit the comment data to the processing terminal. After receiving the comment data, the processing terminal may perform recognition on status information of streaming media of a presenter in the subsequent streaming data, may then use a combination of the status information of the streaming media and the comment data to determine corresponding sound effect data, may include the sound effect data in the subsequent streaming data, and may transmit the streaming data to the target user at the client. In an embodiment, a combination of the comment of the target user viewing the streaming media on the streaming data and a streaming media status of the presenter may be used to determine a sound effect, thereby providing a more suitable sound effect for the target user viewing the streaming media and improving the user experience of the target user viewing the streaming media.

The example embodiments further provide a non-volatile readable storage medium. The storage medium stores one or a plurality of modules (programs). When applied to a device, the one or a plurality of modules enable the device to execute instructions of various method steps according to the example embodiments.

The example embodiments provide one or a plurality of machine-readable media having instructions stored thereon. When executed by one or a plurality of processors, the instructions enable an electronic device to perform the method according to one or a plurality of the above embodiments. In an embodiment, the electronic device includes a server, a terminal device, etc.

The embodiments of the present disclosure can be implemented as an apparatus that uses any suitable hardware, firmware, software, or any combination thereof to perform desired configuration. The apparatus may include electronic devices such as a server (cluster), a terminal, etc.

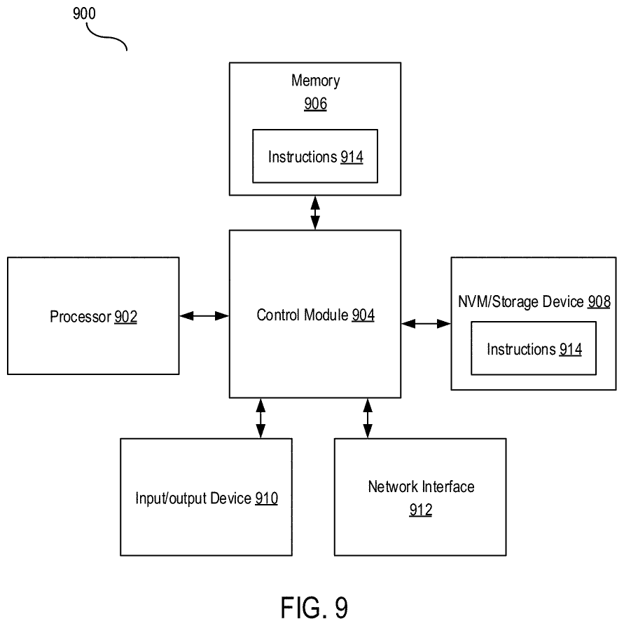

FIG. 9 is a block diagram of an apparatus 900 according to some of the example embodiments. FIG. 9 schematically shows an apparatus 900 that can be used to implement various example embodiments.

For an embodiment, FIG. 9 shows the apparatus 900. The apparatus has one or a plurality of processors 902, a control module 904 (e.g., chip set) coupled to at least one of the (one or a plurality of) processors 902, a memory 906 coupled to the control module 904, a non-volatile memory (NVM) or storage device 908 coupled to the control module 904, one or a plurality of input/output devices 910 coupled to the control module 904, and a network interface 912 coupled to the control module 904.

The processors 902 may include one or a plurality of single-core or multi-core processors. The processors 902 may include any combination of general-purpose processors or special purpose processors (for example, graphics processors, application processors, baseband processors, etc.). In some embodiments, the apparatus 900 can serve as a device, such as the server, the terminal, etc., according to some example embodiments.

In some embodiments, the apparatus 900 may include one or a plurality of computer-readable media (for example, the memory 906 or the NVM/storage device 908) having instructions 914 and one or a plurality of processors 902 coupled to the one or a plurality of computer-readable media and configured to execute the instructions 914 to implement modules to perform actions described in the present disclosure.

For an embodiment, the control module 904 may include any suitable interface controller to provide any suitable interface to at least one of the (one or a plurality of) processors 902 and/or to any suitable device or component in communication with the control module 904.

The control module 904 may include a memory controller module to provide an interface to the memory 906. The memory controller module may be a hardware module, a software module, and/or a firmware module.

The memory 906 may be used to load and store data and/or instructions 914, for example, for the apparatus 900. For an embodiment, the memory 906 may include any suitable volatile memory, such as a suitable DRAM. In some embodiments, the memory 906 may include a double data rate fourth-generation synchronous dynamic random access memory (DDR4 SDRAM).

For an embodiment, the control module 904 may include one or a plurality of input/output controllers to provide an interface to the NVM/storage device 908 and the (one or a plurality of) input/output devices 910.

For example, the NVM/storage device 908 may be used to store data and/or instructions 914. The NVM/storage device 908 may include any suitable non-volatile memory (for example, a flash memory) and/or may include (one or a plurality of) suitable non-volatile storage device(s) (for example, one or a plurality of hard disk drives (HDDs), one or a plurality of compact disc (CD) drives, and/or one or a plurality of digital versatile disc (DVD) drives).

The NVM/storage device 908 may include a storage resource that forms a part of a device on which the apparatus 900 is mounted or may be accessible by the device but not necessarily serve as a part of the device. For example, the NVM/storage device 908 may be accessed over a network via the (one or a plurality of) input/output devices 910.

The (one or a plurality of) input/output devices 910 may provide an interface for the apparatus 900 to communicate with any other suitable device. The input/output devices 910 may include a communication component, an audio component, a sensor component, etc. The network interface 912 may provide an interface for the apparatus 900 to communicate via one or a plurality of networks. The apparatus 900 may wirelessly communicate with one or a plurality of components of a wireless network in accordance with any standard and/or protocols of one or a plurality of wireless network standards and/or protocols such as accessing a wireless network based on a communication standard such as Wi-Fi, 2G, 3G, 4G, 5G, etc., or a combination thereof to perform wireless communication.

For an embodiment, at least one of the (one or a plurality of) processors 902 may be packaged together with logic of one or a plurality of controllers (for example, the memory controller module) of the control module 904. For an embodiment, at least one of the (one or a plurality of) processors 902 may be packaged together with logic of one or a plurality of controllers of the control module 904 to form a system in package (SiP). For an embodiment, at least one of the (one or a plurality of) processors 902 may be integrated on the same die with logic of one or a plurality of controllers of the control module 904. For an embodiment, at least one of the (one or a plurality of) processors 902 may be integrated on the same die with logic of one or a plurality of controllers of the control module 904 to form a system on chip (SoC).

In various embodiments, the apparatus 900 may be, but is not limited to, a terminal device such as a server, a desktop computing device, or a mobile computing device (for example, a laptop computing device, a hand-held computing device, a tablet computer, a netbook, etc.). In various embodiments, the apparatus 900 may have more or fewer components and/or different architectures. For example, in some embodiments, the apparatus 900 includes one or a plurality of cameras, a keyboard, a liquid crystal display (LCD) screen (including a touch screen display), a non-volatile memory port, a plurality of antennas, a graphics chip, an application specific integrated circuit (ASIC), and a speaker.

A detection device may use a master chip as a processor or a control module. Sensor data, location information, etc. are stored in the memory or the NVM/storage device. A set of sensors may be used as the input/output device. A communication interface may include a network interface.

Further disclosed in the example embodiments is an electronic device, including: a processor; and a memory, having executable code stored thereon, wherein when executed, the executable code causes the processor to perform the method according to one or a plurality of the example embodiments.

Further provided in the example embodiments is one or a plurality of machine-readable media, having executable code stored thereon, wherein when executed, the executable code causes a processor to perform the method according to one or a plurality of the example embodiments.

With regard to the apparatus embodiments, because the apparatus embodiments are substantially similar to the method embodiments, the description is relatively concise, and reference can be made to the description of the method embodiments for related parts.

Various embodiments in the specification are described in a progressive way, each embodiment focuses on the differences one has from others; and for the same or similar parts between various embodiments, reference may be made to the description of other embodiments.

The example embodiments are described with reference to flow charts and/or block diagrams according to the method, terminal device (system) and computer program product according to the example embodiments. It should be understood that each procedure and/or block in the flowcharts and/or block diagrams, and a combination of procedures and/or blocks in the flowcharts and/or block diagrams may be implemented with computer program instructions. These computer program instructions may be provided to a general-purpose computer, a special-purpose computer, an embedded processor, or a processor of any other programmable data processing terminal device to generate a machine, so that the instructions executed by a computer or a processor of any other programmable data processing terminal device generate an apparatus for implementing a specified function in one or more processes in the flowcharts and/or in one or more blocks in the block diagrams.

These computer program instructions may also be stored in a computer-readable memory that can direct a computer or another programmable data processing terminal device to operate in a particular manner, such that the instructions stored in the computer-readable memory produce an article of manufacture including instruction means, the instruction means implementing the functions specified in one or more flows of the flowcharts and/or one or more blocks of the block diagrams.

These computer program instructions may also be loaded onto a computer or another programmable data processing terminal device such that a series of operational steps are performed on the computer or another programmable terminal device to produce a computer-implemented processing, and thus the instructions executed on the computer or another programmable terminal device provide the steps for implementing the functions specified in one or more flows of the flowcharts and/or one or more blocks of the block diagrams.

Preferred embodiments of the example embodiments have been described; however, once knowing basic creative concepts, those skilled in the art can make other variations and modifications on these embodiments. Therefore, the appended claims are intended to be interpreted as including the preferred embodiments and all variations and modifications falling within the scope of the example embodiments.

Finally, it should be further noted that in this text, the relation terms such as first and second are merely used to distinguish one entity or operation from another entity or operation, and do not require or imply that the entities or operations have this actual relation or order. Moreover, the terms “include,” “comprise” or other variations thereof are intended to cover non-exclusive inclusion, so that a process, a method, an article or a terminal device including a series of elements not only includes the elements, but also includes other elements not clearly listed, or further includes inherent elements of the process, method, article or terminal device. In a case without any more limitations, an element defined by “including a/an . . . ” does not exclude that the process, method, article or terminal device including the element further has other identical elements.

A method for data processing, an apparatus for data processing, an electronic device, and a storage medium provided by the present application are described in detail above, and the principles and implementations of the present application are described by applying specific examples herein. The above descriptions on the embodiments are merely used to help understanding of the method of the present application and core ideas thereof. Meanwhile, for those of ordinary skill in the art, modifications may be made on the specific implementations and application scopes according to the idea of the present application. In view of the above, the content of the description should not be construed as any limitation to the present application.

1. A method comprising:
obtaining streaming data associated with live broadcast streaming media;
determining status information of the live broadcast streaming media based on the live broadcast streaming data;
determining sound effect data based on the status information of the live broadcast streaming media;
incorporating the sound effect data in the live broadcast streaming data to obtain target live broadcast streaming data; and
transmitting the target live broadcast streaming data to a target user.

2. The method of claim 1, wherein determining status information of the live broadcast streaming media comprises:
obtaining scenario information in the live broadcast streaming data; and
determining the status information of the live broadcast streaming media based on the scenario information.

3. The method of claim 1, wherein determining status information of the live broadcast streaming media based on the live broadcast streaming data comprises analyzing one of audio or image data in the live broadcast streaming data to determine status data of the live broadcast streaming media.

4. The method of claim 3, wherein analyzing audio data in the live broadcast streaming data to determine status data of the live broadcast streaming media comprises:
performing recognition on the audio data to obtain voice feature information; and
analyzing the voice feature information to determine the status data of the live broadcast streaming media.

5. The method of claim 3, wherein analyzing image data in the live broadcast streaming data to determine status data of the live broadcast streaming media comprises analyzing a facial feature and body movement information of a character in the image data to determine the status data of the live broadcast streaming media.

6. The method of claim 1, wherein determining sound effect data based on the status information of the live broadcast streaming media comprises determining the sound effect data based on preference information of a target user viewing the live broadcast streaming media and the status information of the live broadcast streaming media.

7. The method of claim 6, wherein determining the sound effect data based on preference information of a target user viewing the live broadcast streaming media and the status information of the live broadcast streaming media comprises inputting the status information of the live broadcast streaming media, the preference information, and parameter information for configuring the live broadcast streaming media into a sound effect recommendation engine to obtain the sound effect data.

8. The method of claim 7, further comprising:
acquiring target viewing behavior of the target user; and
adjusting the sound effect recommendation engine based on the target viewing behavior.

9. The method of claim 8, wherein adjusting parameters of the sound effect recommendation engine based on the target viewing behavior comprises:
determining, based on the preference information of the target user, a user group associated with the target user;
obtaining other viewing behaviors of other users in the user group; and
adjusting the sound effect recommendation engine based on the target viewing behavior and the other viewing behaviors.

10. The method of claim 6, further comprising:
obtaining historical viewing behavior of the target user; and
determining the preference information of the target user based on the historical viewing behavior.

11. The method of claim 1, wherein incorporating the sound effect data in the live broadcast streaming data to obtain target live broadcast streaming data comprises:
incorporating the sound effect data in display information for displaying; and
receiving a selection instruction for the sound effect data in the display information, and incorporating selected sound effect data in the live broadcast streaming data to obtain the target live broadcast streaming data.

12. A non-transitory computer-readable storage medium for tangibly storing computer program instructions capable of being executed by a computer processor, the computer program instructions defining steps of:
obtaining live broadcast streaming data associated with live broadcast streaming media;
determining status information of the live broadcast streaming media based on the streaming data;
determining sound effect data based on the status information of the live broadcast streaming media;
incorporating the sound effect data in the live broadcast streaming data to obtain target live broadcast streaming data; and
transmitting the target live broadcast streaming data to a target user.

13. The non-transitory computer-readable storage medium of claim 12, wherein determining status information of the live broadcast streaming media comprises:
obtaining scenario information in the live broadcast streaming data; and
determining the status information of the live broadcast streaming media based on the scenario information.

14. The non-transitory computer-readable storage medium of claim 12, wherein determining status information of the live broadcast streaming media based on the live broadcast streaming data comprises analyzing one of audio or image data in the live broadcast streaming data to determine status data of the live broadcast streaming media.

15. The non-transitory computer-readable storage medium of claim 12, wherein determining sound effect data based on the status information of the live broadcast streaming media comprises determining the sound effect data based on preference information of a target user viewing the live broadcast streaming media and the status information of the live broadcast streaming media.

16. The non-transitory computer-readable storage medium of claim 12, wherein incorporating the sound effect data in the live broadcast streaming data to obtain target live broadcast streaming data comprises:
incorporating the sound effect data in display information for displaying; and
receiving a selection instruction for the sound effect data in the display information, and incorporating selected sound effect data in the live broadcast streaming data to obtain the target live broadcast streaming data.

17. A device comprising:
a processor; and
a storage medium for tangibly storing thereon program logic for execution by the processor, the stored program logic comprising:
logic, executed by the processor, for obtaining live broadcast streaming data associated with live broadcast streaming media;
logic, executed by the processor, for determining status information of the live broadcast streaming media based on the live broadcast streaming data;
logic, executed by the processor, for determining sound effect data based on the status information of the live broadcast streaming media;
logic, executed by the processor, for incorporating the sound effect data in the live broadcast streaming data to obtain target live broadcast streaming data; and
logic, executed by the processor, for transmitting the target live broadcast streaming data to a target user.

18. The device of claim 17, wherein determining status information of the live broadcast streaming media comprises:
obtaining scenario information in the live broadcast streaming data; and
determining the status information of the live broadcast streaming media based on the scenario information.

19. The device of claim 17, wherein determining status information of the live broadcast streaming media based on the live broadcast streaming data comprises analyzing one of audio or image data in the live broadcast streaming data to determine status data of the live broadcast streaming media.

20. The device of claim 17, wherein determining sound effect data based on the status information of the live broadcast streaming media comprises determining the sound effect data based on preference information of a target user viewing the live broadcast streaming media and the status information of the live broadcast streaming media.
